(19) United States
(12) Patent Application Publication
(10) Pub. No.: US 2024/0333941 A1
(43) Pub. Date: Oct. 3, 2024

(54) SYSTEMS AND METHODS FOR CONDITIONALLY LOSSLESS VIDEO COMPRESSION

(71) Applicant: BWXT Advanced Technologies LLC, Lynchburg, VA (US)

(72) Inventors: Ryan S. Kitchen, Knoxville, TN (US); Travis A. McFalls, Knoxville, TN (US)

(21) Appl. No.: 18/127,515

(22) Filed: Mar. 28, 2023

(51) Int. Cl. H04N 19/172; H04N 19/182

(52) U.S. Cl. CPC H04N 19/172; H04N 19/182

(57) ABSTRACT

Systems and methods for compression of video camera images include steps, or apparatus for executing steps, of receiving digital image frames from a video source, defining first and second regions within the received image frames, compressing the data from the two regions at different data storage rates, and storing the compressed data.

### TECHNICAL FIELD

The present disclosure generally relates to compression of video camera images and, more particularly, to systems and corresponding methods for video compression.

### BACKGROUND

Video camera imaging systems are often used to observe process conditions in manufacturing chains that may be used to produce objects made from metals and other materials. For example, video camera systems can be used to observe the manufacturing process for objects made of metals (and other materials) using additive manufacturing (AM) techniques or to observe other industrial processes such as welding, machining, or component assembly. Such imaging systems can be used to determine physical properties of materials being produced (e.g., tensile strength and porosity) and/or identify potential failure or defects in the objects being manufactured. Video camera imaging systems may also be used in scientific research applications where high speed, high resolution data is needed for extended periods of time.

Video camera systems used in systems and operations that acquire video for extended periods of time can require the acquisition and storage of large amounts of data, the volume of which can depend on the camera's speed (e.g., defined in terms of the number of image frames acquired per second, or “fps”), resolution (e.g., the number of pixels in each frame), and the bit depth, e.g. the number of bits or bytes per pixel needed to define the pixel's color, gray scale, or black-and-white image value. Thus, for example, a video camera having a 1600 fps speed, a 384×384 (147,456 pixels/frame) resolution, and 2 byte bit depth per pixel generates 471,859,200 bytes/second of data, or approximately 0.5 gigabytes/second. If such a camera system operates, e.g., in a manufacturing facility continuously over a twenty-four-hour period, the camera generates approximately 40 terabytes of data per day. As is apparent, the variation in the camera's characteristics can significantly impact the data storage requirement. For example, a system having a 30 fps frame rate, i.e. much lower than the 1600 fps rate in the example above, but having a resolution of 3000 pixels×4000 pixels (i.e. 12 megapixels) and a bit depth of 3 bytes (e.g., 8 bits red, 8 bits green, and 8 bits blue) generates 1.08 Gbytes of data per second. Therefore, the amount of data produced by such systems may make capture of imagery over a long period of time prohibitively expensive. Further, in order to be considered calibrated, or in-specification, scientific and industrial standards-based quality control measurement applications may require the recording of lossless data.

### SUMMARY OF THE INVENTION

Embodiments disclosed herein relate to systems and corresponding methods for conditionally lossless video compression, for example for use in additive manufacturing. In one or more embodiments, a method of compressing image data includes receiving, at a computer system, a plurality of first digital image frames defined in a sequence to form a video sequence, each first digital image frame having a plurality of pixels within a spatial arrangement of the pixels of the plurality of pixels that is the same for all the first digital image frames in the plurality of first digital image frames. At the computer system, a first plurality of pixel positions are defined within the spatial arrangement and a second plurality of pixel positions are defined within the spatial arrangement. At a computer system, first data are stored from pixels in the first plurality of pixel positions of frames of the plurality of first digital image frames at a first rate. At a computer system, second data are stored from pixels in the second plurality of pixel positions of frames of the plurality of first digital image frames at a second rate, and the first rate is higher than the second rate.

In one or more embodiments, a system for compressing image data has one or more processors, a memory coupled to the one or more processors, and one or more computer programs stored in the memory and configured to be executed by the one or more processors. The one or more computer programs include computer executable instructions that, upon execution by the one or more processors, perform a method. A plurality of first digital image frames defined in a sequence to form a video sequence are received, each first digital image frame having a plurality of pixels within a spatial arrangement of the pixels of the plurality of pixels that is the same for all the first digital image frames in the plurality of first digital image frames. A first plurality of pixel positions are defined within the spatial arrangement, and a second plurality of pixel positions are defined within the spatial arrangement. At a computer system, first data are stored from pixels in the first plurality of pixel positions of frames of the plurality of first digital image frames at a first rate. At a computer system, second data are stored from pixels in the second plurality of pixel positions of frames of the plurality of first digital image frames at a second rate, and the first rate is higher than the second rate.

The accompanying drawings, which are incorporated in and constitute a part of this specification, illustrate one or more embodiments of the invention and, together with the description, serve to explain the principles of the disclosure herein.

### BRIEF DESCRIPTION OF THE DRAWINGS

The disclosure herein refers to the accompanying drawings, in which some, but not all, embodiments of the disclosure are shown. Indeed, the subject matter of this disclosure may be embodied in many different forms and should not be construed as limited to the embodiments set forth herein.

FIG. 1A is a block diagram illustration of compression of images under process of an image compression system and method according to one or more embodiments as disclosed herein;

FIG. 1B is an example of a region of high activity in an image frame processed by an image compression system and method according to one or more embodiments as disclosed herein;

FIG. 2 is a flow diagram illustrating procedures for video camera image compression according to one or more embodiments of a camera image compression method as disclosed herein;

FIG. 3A is a graph of pixel values of an original image prior to compression and encoding according to one or more embodiments of a camera image compression method as disclosed herein;

FIG. 3B is a graph of pixel values of a decoded and decompressed image obtained from the image of FIG. 3A after compression and encoding of the image according to one or more embodiments as disclosed herein;

FIG. 3C illustrates a time series of decompressed output of FIG. 3B overlaid over original time series shown in FIG. 3B;

FIG. 4 is a chart that includes original and compressed image sizes for compressed videos obtained from an additive manufacturing build; and

FIG. 5 is a schematic diagram of a system for compressing data corresponding to images acquired from camera systems, according to one or more embodiments as disclosed herein.

Repeat use of reference characters in the present specification and drawings is intended to represent same or analogous features or elements of one or more embodiments of the invention.

### DETAILED DESCRIPTION

Some example embodiments now will be described more fully hereinafter with reference to the accompanying drawings, in which some, but not all, example embodiments are shown. Indeed, the examples described and pictured herein should not be construed as being limiting as to the scope, applicability or configuration of the present disclosure. It will be apparent to those skilled in the art that modifications and variations can be made in such example embodiments without departing from the scope or spirit thereof. For instance, features illustrated or described in one embodiment may be used in another embodiment to yield a still further embodiment. Thus, it is intended that the present invention covers such modifications and variations as come within the scope of the present disclosure, the appended claims and their equivalents. Like reference numerals refer to like elements throughout.

Further, the term “or,” as used in this application and the appended claims, is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an,” as used in this application and the appended claims, should generally be understood to mean “one or more” unless specified otherwise or clear from the context to be directed to a singular form. Throughout the specification and claims, the following terms take at least the meanings explicitly associated therein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment” or other similar phrase, as used herein, does not necessarily refer to the same embodiment, although it may. The phrase “at least one of A and B” is satisfied by any of A alone, B alone, A and B alone, and A and B with others. The phrase “one of A and B” is satisfied by A, whether or not also in the presence of B, and by B, whether or not also in the presence of A.

The present disclosure relates to systems and corresponding methods for conditionally lossless video compression, for example for use in the operation of camera systems that generate large data volumes, such as in additive manufacturing. As noted above, video camera imaging systems, for example those disposed in fixed positions and having a wide field of view, can be used to observe process conditions in manufacturing chains, such as those used to produce objects made from metals and other materials, or in various types of manufacturing processes, finishing operations, or assembly operations, or in scientific applications. The video cameras used in such systems may have frame acquisition rates, resolution levels, and/or bit depths that generate large amounts of data over the periods of time in which the camera systems are continuously used. The amount of data produced by such systems can, therefore, make capture of such imagery prohibitively expensive over such time periods. For example, since additive manufacturing build operations can take days, or even weeks, to complete (depending on size), data capture can require storage space of more than 20 TB per additive manufacture build, in some instances.

Embodiments disclosed herein may reduce the amount of data storage required to perform post-recording analysis by monitoring video camera outputs in real time, identifying, based on user-defined parameters, regions of interest in the camera image over time that correspond to pixel areas within the image in which the system detects a predetermined level of activity, and recording high fidelity, e.g., lossless, data only for those pixel areas during those periods of time in which such predetermined level of activity is detected. Image regions in which the system does not detect significant activity are stored utilizing low fidelity, i.e. lossy, data storage methods.

In contrast to existing video and/or image compression methods, which often are optimized for human viewing and allow for the decompressed imagery to be different from the original captured video across the entire video sequence, embodiments disclosed herein can provide accurate, as-read, sensor data for various regions of interest depicted in the video sequence, e.g. regions within the image corresponding to an object appearing in the image that is undergoing a manufacturing or finishing process. Other regions in the image, e.g. areas beyond the boundaries of those affected areas, may be compressed by lossy methods, e.g. by known compression methods. The reduction or elimination of error from the data compression within areas in which desired information occurs, while allowing loss within areas without such information, can allow for accurate industrial or scientific modeling of materials undergoing relatively long-term processing without generating unmanageable data storage requirements. Embodiments disclosed herein can realize a compression rate of more than 1:100 over the entire image, with no reduction in the quality of the time series data in regions of interest therein.

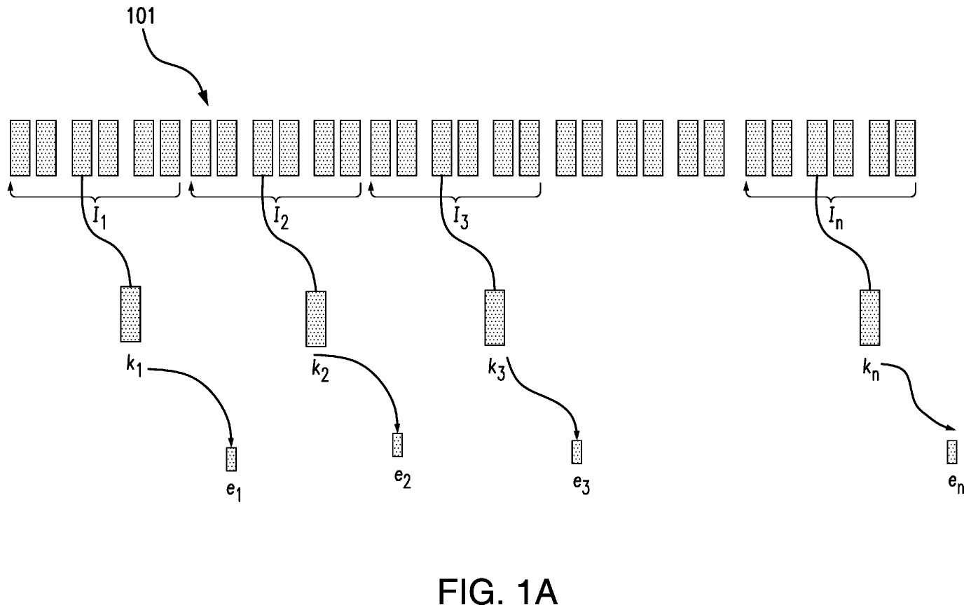

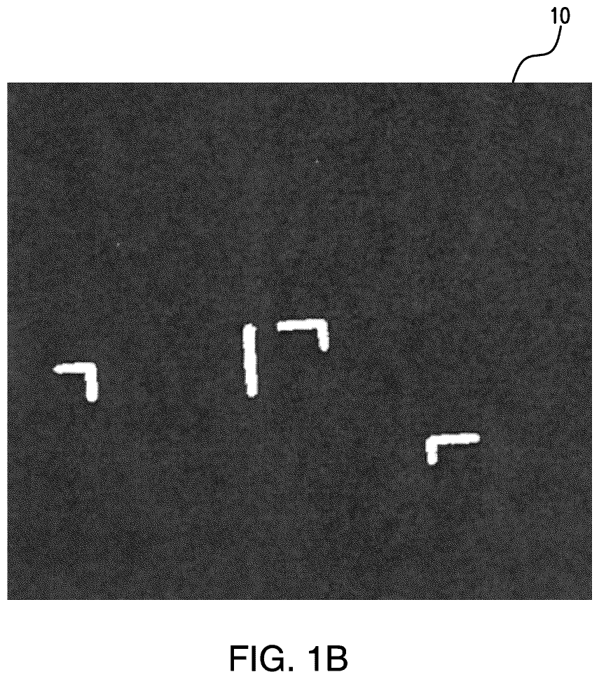

Embodiments disclosed herein can reduce the space required for storing video camera images, while preserving the general viewability of videos generated using such cameras. For example, as shown in FIG. 1A, embodiments disclosed herein can divide raw, uncompressed video frames 101 obtained by cameras into one or more intervals I₁, I₂, I₃, . . . , as determined by a rate parameter, R, that may be based on a minimum framerate required for video that does not contain a region of interest. Where video does not contain a region of interest, R may be based, for example, on a minimum framerate sufficient to present image features that appear consistent to human observation, as opposed to a lower framerate that a human observer would perceive as a sequence of discrete images. In that regard, for example, thirty fps is the standard framerate for broadcast media. For example, if video data is captured at a framerate of 1200 fps, an R of forty is needed (if, as discussed below, a single frame is stored for the interval rather than storing all frames in the interval) to maintain a minimum framerate of thirty fps, in that 1200 fps/40=30 fps. It should be understood, however, that an R value may be selected as desired, for example that results in a minimum framerate different than thirty fps.

Another way to describe rate parameter R in some embodiments, then, is that it is the number of frames of the original video within each interval I₁, I₂, I₃, etc. The system selects one frame, referred to as a keyframe, k₁, k₂, . . . , kₙ from each interval In and records that keyframe in association with its corresponding interval so that the system stores the keyframes in a sequence that is identifiable by a video reader that may display the collection of keyframes as a video sequence in-and-of-themselves at the target framerate or by a computer system that decompresses the keyframes into a video file having the original framerate, as discussed below. In one or more embodiments, the system selects each keyframe at the same position in each interval's time sequence of image frames. Thus, for example, the keyframe might always be the first frame in each interval, or the fifth, or the fiftieth, or any other interval position, though selection of the first keyframe facilitates uniform capture quality within lossy regions.

Upon identifying each keyframe, the system processor may, in some embodiments, convert the keyframe image from its original bit depth to a bit depth at which the keyframes can be encoded into a format, e.g. MJPG, in which the keyframes may be displayed, in-and-of-themselves and without decompression, as a video by a video player configured to display video encoded to that format. MJPG, e.g., is an eight-bit format. Thus, if the original video was captured by a sixteen bit camera, but if it is desired to view the keyframes through an MJPG player, the system processor converts the acquired sixteen bit video data to an eight-bit depth and encodes the converted data, at e₁, e₂ . . . eₙ, in an external file in the desired format, e.g., MJPG, thereby permitting display of the keyframes as a standalone video. In other embodiments, the system does not impose a bit depth conversion, and the system processor simply stores the keyframes, in association with their position data, in local or remote memory at a sixteen-bit depth. Accordingly, in some embodiments that impose a bit depth conversion, this file of keyframes can be viewable, independently, as a lower frame rate version of the original video in various standard players, whereas in embodiments that do not impose a bit depth conversion, the keyframes are viewable using a decoder for the specific file type in which the original video was captured. In both types of embodiments, the lossless data, as described below, is viewable using the decoder for the specific file type. In both these and other embodiments, the keyframes can be used to reconstruct the final video, as discussed below. The keyframes' conversion from a sixteen-bit depth to an eight-bit depth reduces the storage requirement for the keyframes by one half. Thus, in some embodiments, the system processor converts the keyframes' original bit depth as part of the keyframes' storage, regardless whether the keyframes are to be independently displayed.

For example, in some embodiments, the computer system receives video sequence data from a fixed position video camera that records the video sequence at 800 frames per second (meaning that the computer system receives, from that video camera, video sequence frames in a temporal sequence at 800 fps) and compresses that video data using a predetermined interval size, for example 40 frames per keyframe interval. As should be understood, an image frame in digital video is a collection of data representing values of pixels in a predetermined spatial arrangement of pixel positions (e.g., a two-dimensional rectangular, or other perimeter shape, grid pattern) so that the collection of pixel values in that spatial arrangement form a single image that comprises a part of the video sequence at one instant in time. Thus, the frames, arranged in the temporal sequence in which they were recorded, form a video sequence that varies in time at the same speed as the physical image the camera originally recorded when the frames are displayed in sequence by a video player (e.g., on a camera display or a computer system display) at the same speed at which the camera recorded the frames. All of the frames of the video sequence have the same spatial arrangement of pixels, at least within a perimeter that bounds the pixel arrangement area that forms the image. Accordingly, the variations apparent in the video sequence when viewed over time arise from variability in pixel values that occur at the individual pixel positions over time as the video player sequentially displays the image frames. When a computer system stores a digital image frame, the storage of the individual bit values in association with the pixel positions at which they occur can be considered storage of an array, the structure of which associates pixel values with their corresponding pixel positions in the image. As should also be understood, a pixel is the smallest unit of discretely locatable information in the frame, and the bit depth is the number of bits in which the frame defines a given pixel's value (e.g. the pixel's color value or grayscale value).

As discussed above, keyframes form the basis for determining the reconstruction of image pixels outside the regions of interest in one or more embodiments. Thus, returning to the example above, the decision to compress the 800 fps image at a forty-frame interval means that the computer system processor selects every fortieth frame in the 800 fps image as a keyframe and, therefore, in certain embodiments, stores the keyframe in its entirety. The processor does not store the intervening thirty-nine frames (other than the regions of interest within them, as discussed below), and those intervening frames are thereby eliminated from the later reconstituted image. The rate parameter R, then, is 20 fps, since the rate at which the processor stores data for the non-regions of interest is reduced by a factor of twenty. In some embodiments, the system may utilize a 2*R buffer of images, as the activity detection algorithm may be configured to capture lossless data during the keyframe interval leading up to features/movement that occur in the next interval. This may facilitate preservation of subtle features in the data important for end use.

The system processor, discussed below, may convert each keyframe from a sixteen bit depth to an eight bit depth, and in doing so generates and stores two scaling parameters that can be used to perform lossy reconstruction of the sixteen bit original keyframe from the 8 bit keyframe, outside the regions of interest. The processor executes the bit depth conversion, for each pixel in the keyframe, as follows:

$${img}_{8} = ( {img}_{16} - offset ) \times Scaling Factor ,$$

where
img₈ is the converted eight-bit value of a given pixel in the original sixteen-bit keyframe;
img₁₆ is the sixteen-bit value of the same pixel in the original sixteen-bit keyframe;

$$Scaling Factor = \frac{255.}{max ( {img}_{16} ) - min ( {img}_{16} )} ;$$

max(img₁₆) is the maximum sixteen-bit value among the pixels of the original sixteen-bit keyframe;
min(img₁₆) is the minimum sixteen-bit value among the pixels of the original sixteen-bit keyframe; and

$$offset = min ( {img}_{16} ) .$$

The computer system stores each pair of the Scaling Factor and offset parameters in the data file for, or otherwise in association with an identifier of, the keyframe to which the parameters are applicable. In the decompression process, described below, the system retrieves these parameters and uses them to convert the keyframe back to its original bit depth.

In order to provide a desired level of accuracy, for example to meet industrial or scientific standards, in the reconstructed video in those regions of the video sequence in which a sufficient activity occurs over time to warrant examination, one or more embodiments disclosed herein mask out such regions of interest in the incoming image frames over a keyframe interval so that the computer system processor stores pixel data in the compressed data file in full from those regions of interest. Thus, unlike other regions in the video sequence, the data of which the processor stores at a lower rate, e.g. only in the keyframes, the processor stores the pixel data from pixel positions in the regions of interest from all frames in the interval. Thus, considering a data storage rate to be the number incoming digital image frames in a given interval from which the processor stores data from a given pixel position in the compressed file, divided by the number of incoming digital image frames in the interval, the data storage rate for the active pixel positions in the image's pixel arrangement is 100%, whereas for the other, or inactive, pixel positions, the data storage rate (as a percentage) is 1 (for the stored keyframe), divided by R (the number of frames per keyframe), multiplied by 100. That is, in such embodiments, the data storage rate for one image region or another is the percentage of incoming image frames, over the keyframe interval of frames, from which the processor stores pixel data at that image region. In the embodiments discussed herein, the data storage rate for the active regions is higher than the data storage rate for the inactive regions.

The processor makes the distinction between active and inactive regions in the image frames based on the degree to which pixel data in any given pixel position varies from frame to frame over the interval and, in some embodiments, to some degree outside the keyframe interval. In certain embodiments, for example, the computer system processor examining the incoming video stream reviews each frame within a given keyframe interval as it is received. The processor examines the bit value in each pixel of each frame. At each pixel position in the first frame within the interval, the computer system initially records the bit value for the pixel as being both the minimum pixel value and the maximum pixel value. Upon receiving the next frame, the processor compares each pixel value with the current minimum and maximum pixel values for that pixel's position. At the second frame in the interval, the maximum and minimum pixel values for that pixel position will be the same, i.e. the pixel value for that same pixel position in the first frame. If the second frame pixel value is greater than the current maximum pixel value for that pixel position, the processor makes the second frame pixel the maximum pixel value. If the second frame pixel value is less than the current minimum pixel value for that pixel position, the second frame pixel value becomes the minimum pixel value. Else, the minimum and maximum pixel values remain unchanged. The processor repeats this process for the third frame and, then, continues sequentially for the remaining frames in the keyframe interval. As a result, when all frames of the keyframe interval have been received, the processor has identified, for each pixel position in the frames of the keyframe interval, the minimum and maximum pixel values for that pixel position over the keyframe interval. In certain embodiments, for a given pixel position for that interval, these minimum and maximum pixel values are the min(pixelᵢₙₜₑᵣᵥₐₗ) and max(pixelᵢₙₜₑᵣᵥₐₗ) values, respectively, in the analysis below. In addition, the computer system has stored all of the frames for the current keyframe in temporary memory.

In other embodiments, the analysis for identifying the minimum and maximum pixel values for a given pixel position in a keyframe interval considers not only the frames within that keyframe interval, but also a certain number of frames at the end of the immediately preceding keyframe interval (i.e., a certain number of frames immediately preceding the keyframe interval for which computer system processor is defining the minimum and maximum values). Thus, in examining image frames in order to define the minimum and maximum pixel values for each pixel position in a given keyframe interval N (following the first keyframe interval, which considers only the frames within that first keyframe interval) the system processor begins the processes of analyzing pixels, as described above, at a frame within the keyframe N−1. In certain embodiments, e.g., the analysis for keyframe interval N begins at the frame midway through keyframe interval N−1. In other embodiments, the analysis for keyframe interval N begins at other frame positions in keyframe interval N−1, for example the first frame of keyframe interval N−1, or at a frame position in keyframe interval N−2. The frames prior to the keyframe interval N considered in defining the minimum and maximum pixel values may be described herein as a “lookback” period with respect to keyframe interval N. In such embodiments, the process for identifying the minimum and maximum pixel values considers all frames over both the lookback period and keyframe interval N. In other embodiments, the process does not consider all frames in such a frame sequence but, rather, some subset thereof, e.g. every other frame. In any event, the system processor in such embodiments determines the minimum and maximum pixel position values for the frame intervals by considering frames outside the frame interval under analysis (i.e. keyframe interval N) so that the frame groups for which the minimum and maximum pixel values are defined overlap with adjacent groups. The overlap increases a likelihood that changes in the pixel values near the boundary of a keyframe interval, which might not be sufficient, in and of themselves, to qualify as an active area when considering only the pixels in the keyframe interval itself would be more likely to be detected as an active region. Thus, the lookback period introduces a continuity that smooths transitions between pixels being part of active or inactive image regions and that can capture low-intensity effects following an event in the previous interval. In such embodiments, a sufficient length of frames is stored in temporary memory to accommodate the use of lookback periods with keyframe intervals as discussed herein.

Having identified the minimum and maximum pixel value for each pixel position in the frames of a given keyframe interval (and, in certain embodiments, a lookback period), the system processor in certain embodiments can identify those pixel positions that are considered to be active and for which, therefore, the processor will record full fidelity data throughout the current keyframe interval. For example, a keyframe interval pixel position may be considered as active if it satisfies the following:

$${Pixel}_{Active} = ( \frac{max ( {pixel}_{interval} ) - min ( {pixel}_{interval} )}{mean ( {pixel}_{interval} )} > threshold ) ,$$

where:
Pixel_{Active} is a given pixel position within each frame of the frames of a given keyframe interval that satisfies the condition to the right of the “=” in the above relationship;
max(pixelᵢₙₜₑᵣᵥₐₗ) is the maximum pixel value at that pixel position through the frames of the keyframe interval and, if used, the lookback period for that keyframe interval;
min(pixelᵢₙₜₑᵣᵥₐₗ) is the minimum pixel value at that pixel position through the frames of the keyframe interval and, if used, the lookback period for that keyframe interval;
mean(pixelᵢₙₜₑᵣᵥₐₗ) is the average value for that pixel position through the frames of the keyframe interval and, if used, the lookback period for that keyframe interval; and
threshold is a user-defined variable between 0 and 2**x, where x is the video stream's bit depth value.

The test equation compares the pixel position's variability (max-min) to the user-selected threshold, normalizing the variability by dividing into it the mean pixel value so that the threshold is applicable to the pixel variability regardless whether the pixel position is generally of a high or a low value. If Pixel Active is greater than threshold, the corresponding pixel position is considered to be active, else it is inactive. In such a system, it will be understood that where the mean is low and the variability is also low, but there is one or a very few high valued pixels, max-min will be high, with a low mean, resulting in a large ratio. Even if the former situation represents a small anomaly in the data, the resulting lossless data storage is relatively small and may be acceptable in the system's operation.

The selection of the threshold value can be made by the user and programmed into the system via a user interface. For example, the user may use the system with test surfaces of the types of metal with which the system will be used, where the test samples are known to have no regions of interest, recording video data as discussed herein. The system determines the mean value of the resulting pixel data, determines the mean or median pixel value in such data, and presents that value and the standard deviation of the recorded data from that value, to the user via the interface. The user can then enter the standard deviation, or other value determined by the user, as the threshold. In situations in which the video data represents a particular type of scene, in which the threshold can be determined through other types of experimental data or assessment, such as by examination of data acquired by thermal cameras. Still further, the system can automatically update the threshold value, e.g. by tracking data value of recorded schen daa, assumed that all this data should maintain valuations between upper and lower bounds.

It will be understood, in view of the present disclosure, that other methods of identifying active pixels may be employed. For example, the processor may monitor the pixel values in each given pixel position over all frames in the keyframe interval, and in some embodiments additionally over frames in a lookback period, determine the standard deviation, and compare the standard deviation to a user-defined predetermined threshold. The system processor considers those pixel positions in the keyframe interval having a standard deviation above the user-defined threshold to be active and those below the user-defined threshold to be inactive. Further, for example, where video data is acquired from an infrared camera used to detect thermal events, active regions may be considered to occur where pixel values are greater than a predetermined threshold corresponding to images acquired of areas at which flame or otherwise predetermined heat levels occur. Where active regions correspond to predetermined colors, e.g. for use in industrial or agricultural detection, pixels falling within certain predetermined spectral ranges corresponding to colors of interest may define active regions. Still further, in some industrial applications, predetermined symbols, such as QR codes, can be used within a scene to indicate boundaries, e.g. starting and ending points in a linear series of frames, within which the system identifies an active region. Thus, the detection of pixels constituting the QR code defines the beginning or end of such a region. It will, therefore, be understood that the use of minimum and maximum pixel values as discussed herein is provided by way of example, that such example does not limit the present disclosure, and that various methods of defining active status can be used.

Accordingly, in one or more embodiments, the processor may determine which, if any, pixel positions in a keyframe interval will be considered active or inactive, such that the identification of active pixel positions within the space of an image frame may be described as a mask that differentiates the active pixel positions from the inactive pixel positions. Referring to FIG. 1B, for example, consider a perimeter 10 that bounds all pixel positions within the spatial arrangement of pixels in temporally sequential image frames of a video sequence stream. Upon examining the frames of a given keyframe interval as discussed above, the processor may define a mask that differentiates the active pixel positions from the inactive positions. In FIG. 1B, the active positions are indicated by the light areas, whereas the inactive positions are dark. It will be understood that the masks will vary from keyframe interval to keyframe interval and that the image at FIG. 1B is merely for example purposes. Moreover, it will be understood that the mask illustrated at FIG. 1B is for visualization purposes and that the mask is defined in the computer system as a collection of pixel positions within the overall perimeter of frame 10. For example, the computer system may define, and store in a database, a bit array in which each bit in the array corresponds to a pixel position in the spatial arrangement of frame 10. Thus, the bit array represents a two-dimensional coordinate system encompassing frame boundary 10 so that each bit identifies the corresponding pixel position's location in the image frame with respect to each other pixel location. At each such location, the bit is either a one (corresponding to the pixel position's status as active) or a zero (corresponding to the pixel position's status as inactive). Thus, the bit array for each pixel position includes an identifier, in this instance a bit, that identifies the corresponding pixel position as being active or inactive.

Having identified those pixel positions in the keyframe that are considered active and those that are considered inactive, the processor compresses the image data received from the camera device in the frames within that keyframe by storing the frames' pixel data that are in active positions according to a first data storage rate and by storing the frames' pixel data that are in inactive positions according to a second data storage rate, where the first data storage rate is higher than the second data storage rate. The first data storage rate, for example, may be selected to store data over the keyframe interval at a rate that preserves at least a fidelity sufficient to meet requirements of an industrial or scientific system in which the video storage system is used, whereas the second data storage rate, for example, may be selected to store data over the keyframe interval at a lower rate, e.g. one that a human observer would perceive as continuous, uninterrupted video. In some embodiments, for example, the first data storage rate may be (selected by the user through the system user interface as, or predeterminedly set in the system as) the same as the rate at which the camera device acquires image frames. Thus, the computer system stores all the image data in the pixels at the active positions in the incoming frames over the applicable keyframe interval on a 1:1 basis (the processor stores 100% of the pixel data in those pixel positions over the frames of the given keyframe interval). The second data storage rate may be (again, user-selected or preset) a fraction of the rate at which the camera acquires the frame, e.g. 1:R, such that the computer system stores the image data in the pixels at the inactive positions in the incoming frames over the applicable keyframe interval only from the keyframes (if there are X keyframes in the interval, the processor stores ((X/R)*100)% of the pixel data in those pixel positions over the frames of the given keyframe interval). In such embodiments in which the first and second data storage rates are chosen to precise frame intervals, the compression method has the effect of dividing the image data into at least two regions and storing the incoming data in those regions as if the data in the respective regions had been acquired at different camera speeds, where the different effective camera speeds in the compression are selected based on the needs to which the image data is to be put. Thus, it will be understood that, while in certain embodiments described herein the first data storage rate corresponds is maximized to correspond to the actual camera speed at which the video data was acquired and the second data storage rate is set to correspond to a lower camera speed typical for human perception, e.g. 20 fps or 30 fps, the first, second, or other data storage speeds in the presently-discussed embodiments may vary depending on the application in which the stored video data is to be used.

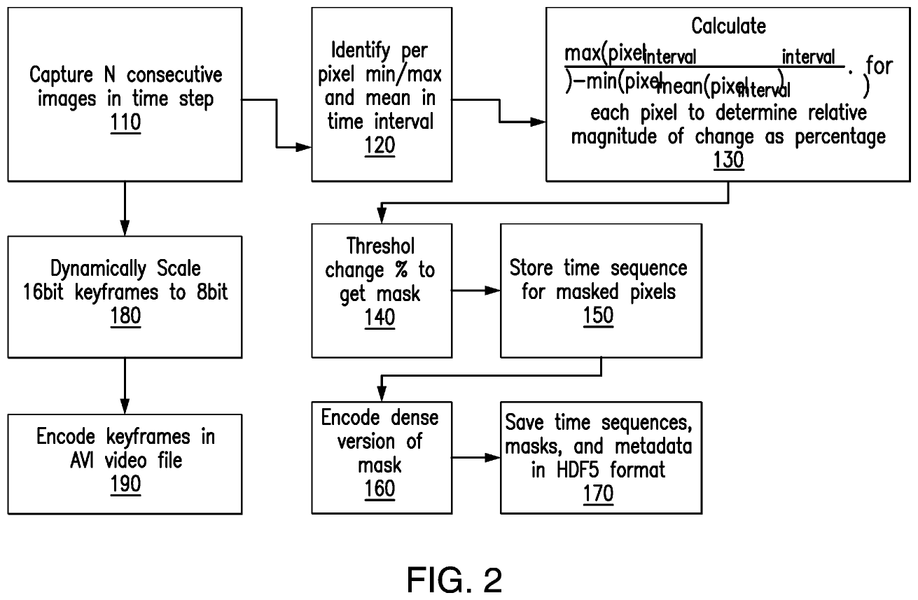

FIG. 2 is a flow diagram of some procedures for video camera image compression according to one or more embodiments disclosed herein. As shown, the image capture and storage system begins image compression by receipt, at a computer system from a video camera device, of a number of (N) consecutive images, in this instance referring to individual image frames, N, over a time interval, at 110. The time step referenced at 110 may be considered the keyframe interval. In those embodiments in which the data analysis discussed above relies only upon the pixel data of the keyframe interval being compressed, the system may retain in temporary storage for such purposes the image data in that one keyframe interval (although, as will be apparent from the present disclosure, image data from other keyframe intervals may also be temporarily stored with the relevant keyframe data). In those embodiments, as discussed above, that operate upon consideration of a lookback period, the system may store in temporary storage at step 110 the image data for the time step/keyframe interval being compressed and a sufficient amount of preceding image data, e.g. the entire data for the immediately preceding one or more keyframe intervals, to encompass the needed lookback period data. Once the computer system obtains the images, then for each pixel position in the images obtained over the keyframe interval (or, if a lookback period is used, the keyframe interval+the lookback period), the computer system processor determines the minimum pixel value (min (pixelᵢₙₜₑᵣᵥₐₗ)), maximum pixel value (max(pixelᵢₙₜₑᵣᵥₐₗ)), and mean pixel value (mean(pixelᵢₙₜₑᵣᵥₐₗ)) over the frames within that time period and within that pixel position, at 120.

Having obtained these values, the computer processor, executing the computer program's computer executable instructions that implement the methods as disclosed herein, determines whether a given pixel position is considered as active or inactive, such that its data is stored at the first data storage rate or the second data storage rate. At 130, the processor uses the minimum, maximum, and mean values for each pixel position in the interval frames to respectively calculate:

$$\frac{max ( {pixel}_{interval} ) - min ( {pixel}_{interval} )}{mean ( {pixel}_{interval} )} .$$

As discussed above, this value corresponds to the relative magnitude percentage change in the values of the pixels at the give pixel position over the interval (or the interval+lookback). At 140, the computer system processor compares this percentage change against the user-defined threshold. If the percentage change for a given position is greater than, or greater than or equal to, the threshold at 130, the processor identifies that pixel position to be active, else the processor identifies the position to be inactive. As discussed above, the processor generates an array identifying the active/inactive status of each pixel position in the interval frames, so that these designations over all the pixel positions, collectively, define the mask. Having defined the mask, the processor, at 150 for each pixel position designated as active, may store in temporary or other local memory the pixel position's time sequence (in this example, the frames' pixel values at that position, in sequence according to how the computer system received the frames in time from the camera system that acquired the image frames) for all frames in the keyframe interval. This assumes that the first data storage rate, discussed above, is set to correspond to the speed of the camera that acquired the image data. If, instead, the first data storage rate is less than the camera speed, the processor stores the pixel data for the active positions from fewer than all of the frames within keyframe interval, where one or more frames within the interval are skipped over with regard to data storage (in certain embodiments, the passed-over frames are spaced apart evenly throughout the keyframe interval) to achieve the desired first data storage rate. Also, at 150, the processor stores, in temporary or other local memory, the pixel data for the inactive pixel positions according to the second data storage rate. For example, if the second data storage rate is set to store the inactive data at a ratio of 1:R with respect to the camera speed, then the processor stores the single keyframe, thereby storing the pixel data for each inactive pixel position, without storing pixel data for the inactive pixel positions from the other frames in the interval. If, instead, the second data storage rate corresponds to a storage ratio greater than 1:R, the processor stores a sufficient number of keyframes in the interval (e.g., where the keyframes are evenly spaced apart from each other within the interval) to achieve the second data storage rate with regard to the inactive pixels.

The processor stores the time sequences of the active pixel positions in an array that is associated in the database with the keyframe for the interval to which the active pixel positions correspond. At 160, the processor stores the mask data as a bit array. The stored mask bit array correlates the time sequences in the data array to their pixel positions in the keyframes, thereby allowing application of the steps to correctly extract the time sequences into a decompressed video file, as discussed below. The processor encodes the time sequences using the bitmask. The processor, under the algorithm, scans across the bitmask from top left to bottom right. At each “1” position in the bitmask, the processor appends the lossless time series for the keyframe interval for that pixel to the flat file. That is, the system applies the keyframe mask, which identifies the active pixel positions, to all frames in the keyframe interval to thereby identify the active pixel data in all frames within that interval and, consequently, save that active pixel data at the 100% rate discussed in one or more examples herein. The processor may also perform decompression, discussed below, using the bit mask, as each “1” pixel causes the processor/algorithm to reach one pixel's value for the entire keyframe interval. Thus, in such embodiments, the processor stores only the time series data for the respective pixels, without need save position data, thereby maintaining a relatively higher compression rate. In other embodiments, encoding the positions of individual pixels could provide improved compression if the total number of active pixels is less than 1/32 of the total image, according to the relationship that 4p implies t/8 and t/8 implies 4p, where “p” represents active pixels and “t” represents total pixels.

Optionally, at 180 and 190, the keyframes of the respective keyframe intervals corresponding to the compressed image data can be scaled to a bit depth that allows the keyframes to be encoded in a video file format that allows the keyframes themselves to be viewed as a standalone video. In such an embodiment, e.g, assume that the camera system acquires sixteen bit image data and that the desired image file format, e.g. “.avi,” operates at an eight bit depth. At step 180, the processor converts the keyframe for a given keyframe interval from a sixteen-bit depth to an eight-bit depth, e.g. using the conversion process set forth above. At 190, the processor encodes the now-eight bit keyframe data into a video format, e.g. .avi, and stores the converted and encoded keyframe as the keyframe data at step 150, as discussed above. In other embodiments, the processor converts the keyframes to an eight-bit depth, but without converting to a video format, thereby reducing storage requirements for the keyframe even though video display of the keyframes is not required.

The processor stores the compressed data, including the 1:1 active pixel data and the 1:R inactive pixel data, in permanent memory, either at the processor's computer system or at another computer system or other memory, at 170. The processor may, in some embodiments, store the compressed data in either a single file or in respective files for the 1:1 data and the 1:R data. For example, the processor may store all the data in a single HDF5 file or may store the 1:1 data in an HDF5 file and the 1:R data (e.g. the keyframes) in a playable AVI video file, thereby facilitating the ability to play the keyframe data through other players.

The processor may also store, with the data, certain information and parameters needed to reconstruct the video data. In some embodiments, in order to effectively store the various data elements used in this process, the system processor can use an encoding format to store the video files generated at steps 150 and 160, as well as metadata corresponding to the video data that may be needed for its decompression and/or display. For example, at 170, the processor may use the known HDF5 file format to store most or all of the key elements of the compressed information. The encoded, stored file can include any suitable information, for example, one or more of: information regarding interval masks, interval masks (e.g. the bit masks corresponding to the keyframes that indicate locations of active pixels), the lossless time sequences from the active pixel positions presently stored in temporary memory, keyframe bit depth scaling constants such as the “Scaling Factor” and “offset” parameter values as discussed above, encoding rate R, minimum and maximum values for the full video (used for video playback in 8 bit mode) lossless keyframes (i.e. keyframes stored in their original bit depth and otherwise without compression), keyframes converted to a lower bit depth, such as from sixteen bit to eight bit, and location of the keyframe video file. Further, in some implementations, the lossy keyframes can be stored in a file, such as a “.avi” file containing the MJPG encoded keyframe video. The “minimum and maximum values for the full video” referenced above are used for scaling of sixteen bit to view on a standard eight bit monitor over the full video and is distinct from the keyframe scaling discussed above.

Accordingly, the compressed video file comprises the data time sequences, the keyframes, the bit masks for the keyframes, the parameters used to convert the keyframes to a lower bit depth, if that step is performed, and the location of the keyframe video file.

The computer system may use the compressed video file to decompress the video data so that it may be viewed by a camera system or other system at the video's original speed. For example, for each respective keyframe interval in the compressed video, the processor loads from the permanent memory into temporary memory the data stored from two adjacent keyframes from the original video sequence (the last frame in the video sequence will, in one or more embodiments, always be designated a keyframe, regardless of the number of frames between it and the previous keyframe) from memory as two image frames of the reconstructed video. If the original keyframes were scaled to a lower bit depth as part of the compression and storage process, as discussed above, the processor scales them back up to their original bit depth (e.g., up to 16 bit frames) using the saved scaling constants, e.g. Scaling Factor and offset, in the reverse of the 16-bit-to-8-bit conversion discussed above: img₁₆=(1/Scaling Factor)img₈+offset. The first of the two new image frames corresponds to the original keyframe that the processor stored for the interval being reconstructed and is referenced herein as the “current interval” keyframe. The other original keyframe, referenced as the “next interval” keyframe, is the original keyframe for the next sequential interval. The processor, under control of the computer program, interpolates the pixel values of the current interval keyframe with the corresponding pixel values (the pixel values in the same pixel positions as in the current interval keyframe) of the next interval keyframe to define reconstructed other new image frames for the current interval for which the processor did not save original image frames in the compression/encoding steps. For example, a reconstructed pixel value may be calculated by a weighted sum of the values in the two neighboring keyframes at that pixel value based on a time sequence. Consider, for instance, a keyframe from timestep 0 and a keyframe from timestep 30, for reconstruction of a pixel for timestep 10. The value would be: Frame₁₀=((30−10)/30)*Keyframe₀+(10/30)*Keyframe₃₀.

The processor defines each such reconstructed new image frame from the current interval/next interval keyframe interpolation, in a position in the new image frame interval corresponding to the position of the original image frame to which the reconstructed new image frame corresponds in the original video. The interpolation's result, i.e., the collection of the current interval keyframe with the reconstructed frames in the same interval, is referenced herein as the “base image.” The base image has the same number of image frames, in the same sequence, for that interval as did the original video. The data in the new image frame(s) corresponding in the sequence within the interval to the one or more original keyframes is the data stored for those original keyframes, possibly converted back to the original bit depth at which the camera originally acquired those keyframes.

The processor then loads, from the permanent memory into temporary memory, the current interval's time sequence data that the processor had previously stored for the active pixel positions, as discussed above, and the current interval's mask. The processor identifies from the mask the pixel position for each such time sequence and replaces the data at that pixel position in the interval's new keyframe(s) and reconstructed frames with the respective original active pixel data corresponding to those new image frames in the interval. That is, the processor stores the original pixel data from the first, second, third, etc. digital image frames in the original sequence of image frames in the interval in the first, second, third, etc. new digital image frames for the same interval. This overwrites, for the active pixel positions, the low fidelity data in those frames from the base image with the high-fidelity data from the original image, through the entire interval. The inactive pixel positions in all the interval frames remain the re-converted keyframe vales (for the reconstructed keyframe(s)) or the interpolated values (for the reconstructed new digital image frames between adjacent reconstructed keyframes). This can significantly reduce the time required for compression as compared to traditional video compression codecs, which may require more advanced math operations to rebuild an image.

The decompression codec can be used to directly extract time series data for individual pixels or slices of pixels, instead of the whole video/image time series. This enables examination of large (e.g., >20 GB) time series data on low-spec personal computers with lower system memory than the original dataset. Further, the losslessly-recorded (in embodiments in which regions of interest are stored as 1:1 data) image masks can also be extracted. This image mask can be used to identify regions of interest and track activity in videos, simplifying downstream data processing. This step may be effected through a PYTHON interface. For example, sections of the video can be extracted by index as if it were a three-dimensional volume. For instance, if the output desired was a section from pixels 100-200 on the x axis, 200-400 on the y axis, and from frames 1000-2000, these can be indexed by ROI-videoFile.video[1000:2000, 200:400, 100:200]; Mask=videoFile.mask[1000:2000, 200:400, 100:200].

In the context of additive manufacturing, given that embodiments disclosed herein store data that is relevant to the build/experiment, the resulting images can be used to maintain accurate temporal records of detected events. Further, although the resulting images in some embodiments are lossless, as-read measurements for regions of interest, with no compression decay, they have been compressed to the extent that they allow for viewing of possibly extremely large time series data on a traditional personal computer. Moreover, these images allow for automatic identification of regions of interest for data processing. Additionally, embodiments disclosed herein can provide extremely high compression ratio (e.g., 1:100 average ratio for full layer on Arcam E-beam system) and very high-speed compression and decompression (e.g., faster than 1000 frames per second using CPU only).

In contrast, existing codecs (e.g., H.264/H.265 Lossless encoding, MJPG 2000 Lossless encoding, or FFV1 Lossless encoding) generally do not support 16 bit video and have low compression rates (e.g., compression rate of 1:4). Further, traditional codecs are often too slow to keep up with the speed of the compression codec. For example, existing systems that distinguish between active and non-active pixels may change the non-active pixels to a constant value but then compress all the pixels in the frames at the same framerate. In one or more examples discussed herein, however, the system stores the active pixels at a framerate (e.g., 100%) higher than the framerate at which the background pixels are stored. The system stores the data (both active and background) losslessly at both framerates (though, due to the lesser framerate for the background pixels, data for the background pixels in frames that are not keyframes are not stored, so that those pixel positions are filled through interpolation, as discussed herein). Thus, storage of the background data is lossless in the context of the framerate at which it is stored but lossy in the context of the overall video sequence, whereas storage of the active pixels is, in examples discussed herein, lossless both in terms of the framerate and in terms of the overall video.

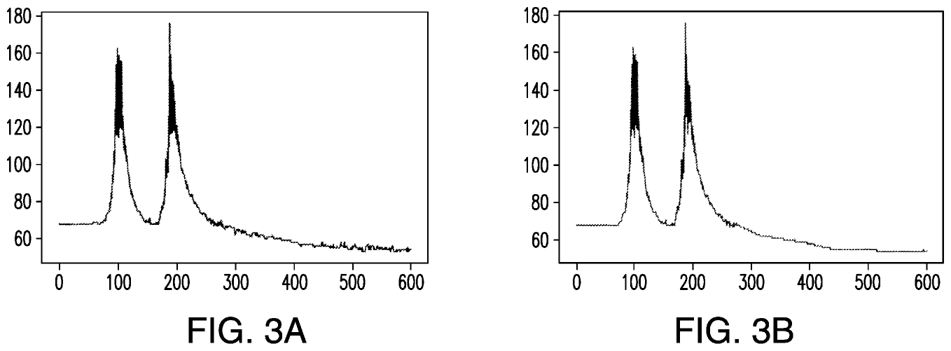

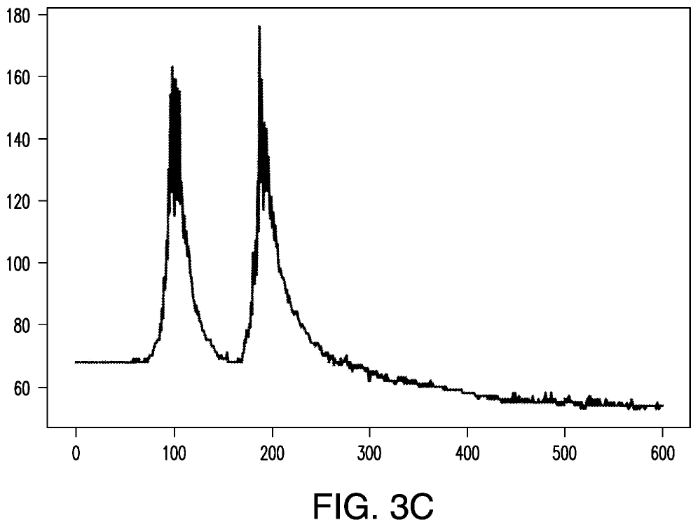

FIG. 3A illustrates an original high speed time series graph for a melt event. FIG. 3B illustrates a graph of a decompressed time series that is obtained from the original high speed image (FIG. 3A) using embodiments disclosed herein. These graphs were prepared using a two-second clip of a 800 FPS video. As shown the original high speed image was initially graphed in FIG. 3A. The image was subsequently compressed, encoded, decompressed, and decoded. The resulting decoded image is shown in FIG. 3B. As shown in FIG. 3C, which illustrates the time series of decompressed output overlaid over original time series, the decompressed and decoded graph captures and maintains the characteristics of the original image, and there is very little event loss and/or loss of data fidelity. Small details are captured during event.

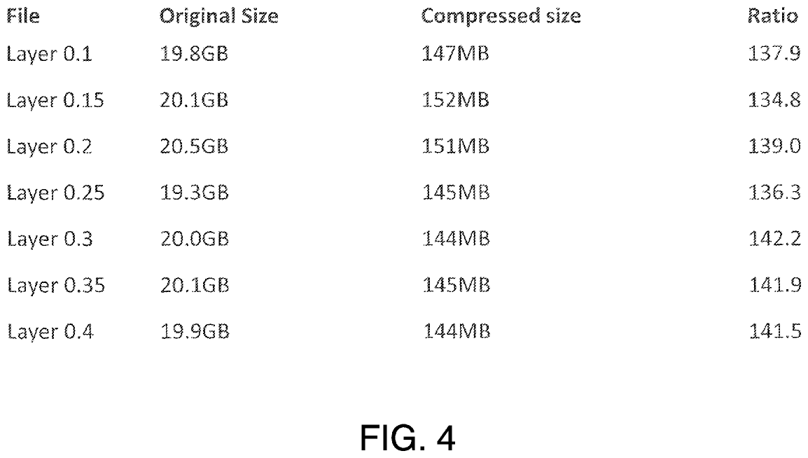

Embodiments disclosed herein can significantly reduce the amount of storage required for storing high speed camera images. FIG. 4 is a chart that includes the original and compressed image sizes for compressed videos obtained from an additive manufacturing build. Each build can consist of thousands of layers, and each layer can consume approximately 20 GB of storage space for an uncompressed HSIR video. As shown, the compressed version of the images is significantly smaller (e.g., over 130 times) than the original images.

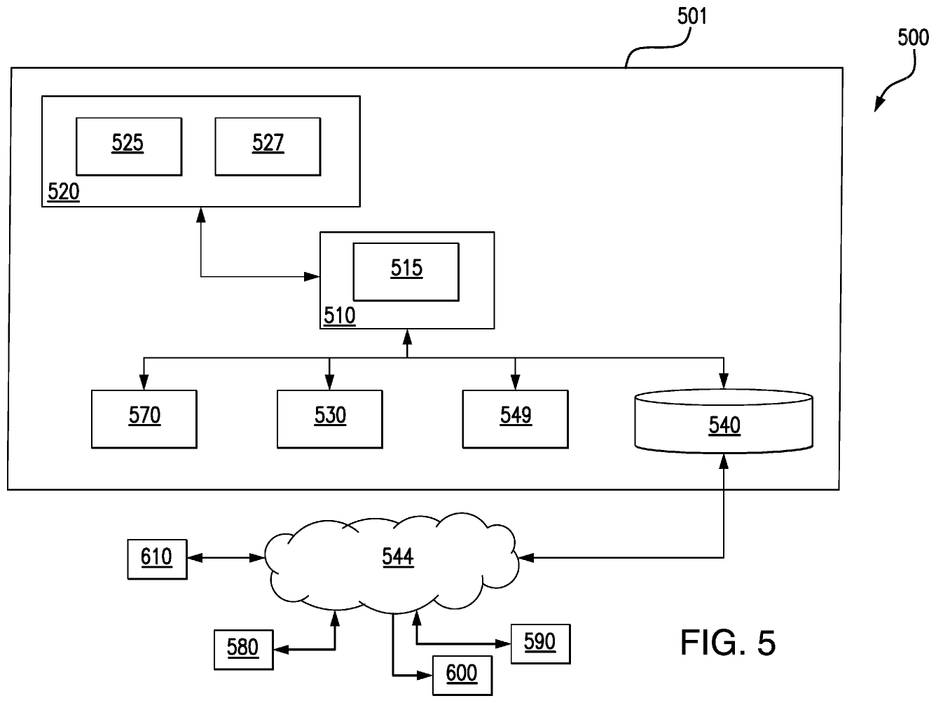

FIG. 5 is a high-level block diagram of digital electronic circuitry and hardware 500, for example including a computer system 501, that can be used with, incorporated in, or fully or partially included in embodiments disclosed herein. Computer system 501 can include a processor 510 that is configured to monitor the operation of a system for conditional lossless compression of high speed camera images according to embodiments disclosed herein, send and/or receive signals regarding the operation of such system, and/or control the operation of such system. Computer system 501 may be a server, a non-server computer system such as a personal computer or a mobile device, or may comprise a plurality and/or combination of such computer systems, but is generally a computing device or devices capable of effecting the communications and functions as described herein. Where computer system 501 is a server accessible over a local area network or at a locationally remote data center accessible over a wide area network such as the Internet, as discussed below, the computer system may be considered to include a workstation, mobile computer, or other device through which such access is effected. In general, it should be understood that a single computer device need not execute all the computer-related steps disclosed herein and more specifically with respect to FIG. 5 and that multiple devices may be used.

Processor 510 can be configured to collect or receive information and data (e.g., digital image frames from a fixed position, large field of view, high speed video camera 580) and/or store or forward information and data to another entity (e.g., another portion of the system such as database 530, an external computer system 600 having its owner permanent memory and that may be a remote server, an external video player 590, an external non-volatile memory 610, etc.). Processor 510 can further be configured to control, monitor, and/or carry out various functions needed for analysis, encoding, compression, decompression, decoding, and storing of information and data collected by the one or more high speed cameras. Generally, these functions can be carried out and implemented by any suitable computer system and/or in digital circuitry or computer hardware, and the processor 510 can implement and/or control the various functions and methods described herein.

Processor 510 can be connected to a main memory 520 of computer system 501 and may comprise a central processing unit (CPU) 515 that includes processing circuitry configured to manipulate the computer program's computer-executable instructions received from main memory 520 and to execute the various instructions. CPU 515 can be any suitable processing unit known in the art. For example, CPU 515 can be a general and/or special purpose microprocessor, such as an application-specific instruction set processor, graphics processing unit, physics processing unit, digital signal processor, image processor, coprocessor, floating-point processor, network processor, and/or any other suitable processor that can be used in a digital computing circuitry. Alternatively or additionally, processor 510 can comprise at least one of a multi-core processor and a front-end processor.

Generally, processor 510 and CPU 515 can be configured to receive computer program executable instructions and data from main memory 520 (e.g., a read-only memory or a random access memory or both) and execute the instructions, for example executing the process steps discussed hereinabove. The computer executable instructions and other data can be stored in main memory 520. Processor 510 and main memory 520 can be included in or supplemented by special purpose logic circuitry. Main memory 520 can be any suitable form of volatile memory, non-volatile memory, semi-volatile memory, or virtual memory included in machine-readable storage devices suitable for embodying data and computer program instructions. For example, main memory 520 can comprise magnetic disks (e.g., internal or removable disks), magneto-optical disks, one or more of a semiconductor memory device (e.g., EPROM or EEPROM), flash memory, CD-ROM, and/or DVD-ROM disks.

Main memory 520 can comprise an operating system 525 that is configured to implement various operating system functions. For example, operating system 525 can be responsible for controlling access to various devices, memory management, and/or implementing various functions of the compression system. Generally, operating system 525 can be any suitable system software that can manage computer hardware and software resources and provide common services for computer programs.

Main memory 520 can also hold application software 527. For example, main memory 520 and application software 527 can include various computer executable instructions, application software, and data structures, such as computer executable instructions and data structures that implement various aspects of the embodiments described herein. For example, main memory 520 and application software 527 can include computer executable instructions, application software, and data structures, such as computer executable instructions and data structures that implement the compression, encoding, decoding, and decompression procedures described herein. The program code that can be used with the embodiments disclosed herein can be implemented and written in any form of programming language, including compiled or interpreted languages, and can be deployed in any form, including as a stand-alone program or as a component, module, subroutine, or other unit suitable for use in a computing environment. A computer program can be configured to be executed on a computer, or on multiple computers, at one site or distributed across multiple sites and interconnected by a communications network, such as the Internet.

One or more methods as disclosed herein may be embodied in or performed by an execution module of application software 527. The execution module may be a self-contained software system with embedded logic, decision-making, state-based operations and other functions that may operate in conjunction with collaborative applications, such as web browser applications, software applications, and other applications that can be used to communicate with the user, as discussed herein, and in one or more embodiments disclosed herein comprises computer-executable instructions stored on the computer-readable medium as disclosed herein, e.g. as embodied by processor 510 or a programmable logic controller. Such a computer program may be comprised of a multitude of instructions that may be translated by the processor into a machine-readable format and hence executable instructions. In one or more embodiments as disclosed herein, the computer system stores the execution module on a file system or memory, accesses the execution module from the file system, and runs the execution module on processor 510.

The execution module may include various submodules to perform the steps disclosed herein, including the submodule, indicated at 540 and discussed below, that interfaces with other computer systems, such as one or more video cameras 580, other computer system 600, video player 590, and external memory 610, to allow the user to upload and/or download information.

Generally, the procedures described herein can be implemented in digital electronic circuitry or in computer hardware that executes software, firmware, or combinations thereof. The implementation can be as a computer program product (e.g., a computer program tangibly embodied in a medium such as a non-transitory machine-readable storage device, such as memory 520) for execution by or to control the operation of a data processing apparatus (e.g., a computer, a programmable processor, or multiple computers).

Main memory 520 can also comprise temporary memory (not shown) into which incoming data from external devices may be received for operation by the processor according to the methods disclosed herein and may be connected to a cache unit (not shown) configured to store copies of the data from the most frequently used main memory 520.

Processor 510 can further be coupled to a database or data storage 530 of computer system 501. Data storage 530 can be configured to store information and data relating to various functions and operations described herein. For example, data storage 530 can store the data collected by the one or more high speed cameras 580 and compressed by application 527. The computer program's interface module allows the computer system to query and receive data from database 530 and distribute received data to one or more other program submodules in the execution module, as appropriate, for further processing. A query to a database submodule may take the form of a command message that presents a command to the appropriate computer system or database, such that the interface submodule in turn compiles the command and executes the requested function, such as retrieving information from database 530.

The execution module may also include one or more graphical user interfaces (“GUIs”). The execution module may present, for instance, one or more predetermined GUIs to permit a user to input/select data into the system, direct computer system 501 to perform various functions, define preferences associated with a query, or input other information and/or settings. The GUIs may be predetermined and/or presented in response to attempts by the user to perform operations, such as those discussed herein, execute queries, enter information and/or settings, operate functions of other modules, or communicate with other computer systems. Computer system 501 generates the predetermined GUIs and presents the GUIs to the user on display 570, which may be at the local computer system 501 or at a remote computer system 600, as disclosed herein. The GUIs may be custom-defined and execute in conjunction with other modules and devices on computer system 501, such as the interface submodules indicated at 549 and 540, or any other submodule. The GUIs present notifications to users and may be used whenever a user desires to transmit or receive data between computer systems, databases, and/or devices.

The execution module also includes a custom module. The custom module is a set of computer executable instructions that effects the steps discussed above, e.g., with regard to video data compression and video reconstruction, encompassed by the application. It receives input data, as discussed herein, from the one or more video cameras 580 and from the user, either directly via the I/O devices or display 570 and interfaces 549 and 540, or from external computer systems 600 and interface 540. The custom module executes the data compression and reconstruction and displays the outputs of those operations at display 570 and/or at external computer system 600. The custom module may also store the compressed video data at database 540 via the interface module or at an external device 610 or 600 via interfaces 549 or 540.

Processor 510 can further be coupled to a display 570. Display 570 can be configured to receive information and instructions from the processor. Display 570 can generally be any suitable display available in the art, for example a Liquid Crystal Display (LCD) or a light emitting diode (LED) display. For example, display 570 can be a smart and/or touch sensitive display that can receive instructions from a user and/or provide information to the user. The display may display for the user, e.g., a GUI through which the user can provide inputs and instruction to the processor and the program as the processor executes the program and through which the processor and the program can provide information to the user. Via such a display, e.g., the user can provide instructions to the processor to start and stop the receipt of data from one or more digital video cameras 580, to start and stop the compression of video data from the one or more digital video cameras, to store the compressed data locally (e.g. at database 530) or remotely (e.g. at external memory 610 or external computer system 600), to retrieve previously compressed and stored video sequence data from such local or external memory sources and reconstruct video sequence frames from the previously stored data as discussed herein, and to display the reconstructed video sequence at display 570. The user can also enter parameters needed by application 527, e.g., R and threshold.

Processor 510 can further be connected to various interfaces. The connection to the various interfaces can be established via a system or an input/output (I/O) interface 549 (e.g., Bluetooth, USB connector, audio interface, FireWire, interface for connecting peripheral devices, etc.) of computer system 501. Thus, interface 549 may connect the processor to user I/O devices, such as a keyboard or mouse, through which the user, while viewing the GUI as discussed above, may alternatively communicate with the processor and the program via the GUI for the same purposes as set forth above. Further, the external devices illustrated in FIG. 5, such as video camera 580, external computer system 600, video player 590, or external memory 610, may communicate with the processor and the computer program via wired connections through interface 549 rather than through communications network 544.

In that regard, processor 510 can further be coupled to a communication interface 540 of computer system 501, such as a network interface configured to provide a connection to a suitable communications network 544, such as the Internet. Transmission and reception of data, information, and instructions can occur over the communications network 544, such as to and from video camera 580, external computer system 600, video player 590, or external memory 610. Further, in some embodiments, communications interface 540 can be an interface that is configured to allow communication between computer system 501 and a remote computer system, such as computer system 600, via any suitable communications means such as a wired or wireless communications protocol, including WIFI and Bluetooth communications schemes.

It should also be understood from the present disclosure that the user may interact with processor 510 and the computer program via remote computer system 600, which may be, e.g., a standalone desktop computer system or a mobile computing system, such as a mobile telephone. In such arrangements, processor 510 and the computer program communicate with the processor of computer system 600 through communication interface 540 to drive the processor at computer system 600 to display the GUIs and so that the user can utilize the I/O capabilities of computer 600 to interact with the user interface as discussed herein, with the processor of computer system 600 communicating with processor 510 via interface 540 and the intervening network, such as at 544, to establish communication between the user and processor 510 as disclosed herein. In such an arrangement, computer system 501 may comprise a server with which the user, at remote computer system 600, communicates through a cloud arrangement.

Those having ordinary skill in the art will appreciate that various changes can be made to the above embodiments without departing from the scope of the invention. Although this specification discloses advantages in the context of certain illustrative, non-limiting embodiments, various changes, substitutions, permutations, and alterations may be made without departing from the scope of the specification as defined by the appended claims. Further, any feature described in connection with any one embodiment may also be applicable to any other embodiment.

1. A method of compressing image data, comprising the steps of:
receiving, at a computer system, a plurality of first digital image frames defined in a sequence to form a video sequence, each first digital image frame having a plurality of pixels within a spatial arrangement of the pixels of the plurality of pixels that is the same for all the first digital image frames in the plurality of first digital image frames;
defining, at the computer system, a first plurality of pixel positions within the spatial arrangement and a second plurality of pixel positions within the spatial arrangement;
storing, at a computer system, first data from pixels in the first plurality of pixel positions of frames of the plurality of first digital image frames at a first rate; and
storing, at a computer system, second data from pixels in the second plurality of pixel positions of frames of the plurality of first digital image frames at a second rate,
wherein the first rate is higher than the second rate.

2. The method as in claim 1, wherein:
for each pixel position in the first plurality of pixel positions, the first rate is defined as a first percentage of pixels at said pixel position in the first plurality of pixel positions over a predetermined interval of the first digital image frames, and
for each pixel position in the second plurality of pixel positions, the second rate is defined as a second percentage of pixels at said pixel position in the second plurality of pixel positions over the predetermined interval.

3. The method as in claim 2, wherein the first percentage is 100%.

4. The method as in claim 3, wherein the second percentage corresponds to one said first digital image frame over the predetermined interval.

5. The method as in claim 1, wherein:
the step of storing the first data comprises associating the first data in a computer system memory with position of the first data in the spatial arrangement and
the step of storing the second data comprises associating the second data in a computer system memory with position of the second data in the spatial arrangement.

6. The method of claim 5, wherein the step of associating the first data comprises storing in a computer system memory a map that correlates the first data with the position of the first data in the spatial arrangement.

7. The method of claim 1, wherein the step of storing the first data comprises storing the first data without modification of the first data and the step of storing the second data comprises storing the second data without modification of the second data.

8. The method of claim 1, wherein the step of storing the first data comprises changing bit depth of the first data and the step of storing the second data comprises changing bit depth of the second data.

9. The method of claim 5, wherein the step of associating the second data comprises storing the second data in an array that conforms to the spatial arrangement.

10. The method of claim 1, comprising:
generating, at a computer system, a plurality of second digital image frames in the sequence, each second digital image frame having a plurality of pixels in the spatial arrangement,
for each pixel position of the first plurality of pixel positions, defining, in the second digital image frames at the first rate and at a pixel position in the spatial arrangement in the second digital image frames corresponding to that pixel position of the first plurality of pixel positions, data corresponding to the data stored, for that pixel position of the first plurality of pixel positions, at the step of storing the first data, and
for each pixel position of the second plurality of pixel positions, defining, in the second digital image frames at the second rate and at a pixel position in the spatial arrangement in the second digital image frames corresponding to that pixel position of the second plurality of pixel positions, data corresponding to the data stored, for that pixel position of the second plurality of pixel positions, at the step of storing the second data.

11. The method of claim 2, comprising:
generating, at a computer system, a plurality of second digital image frames in the sequence, each second digital image frame having a plurality of pixels in the spatial arrangement,
for each pixel position of the first plurality of pixel positions,
defining, in the second digital image frames at the first percentage in an even distribution over the predetermined interval and at a pixel position in the spatial arrangement in the second digital image frames corresponding to that pixel position of the first plurality of pixel positions in the first digital image frames, third data corresponding to the data stored, for that pixel position of the first plurality of pixel positions, at the step of storing the first data, and
if the first percentage is less than 100%, defining remaining pixels, at the pixel position in the spatial arrangement in the second digital image frames corresponding to that pixel position of the first plurality of pixel positions in the first digital image frames, by interpolating the third data, and
for each pixel position of the second plurality of pixel positions,
defining, in the second digital image frames at the second percentage at an even distribution over the predetermined interval and at a pixel position in the spatial arrangement in the second digital image frames corresponding to that pixel position of the second plurality of pixel positions, fourth data corresponding to the data stored, for that pixel position of the second plurality of pixel positions, at the step of storing the second data, and
if the second percentage is less than 100%, defining remaining pixels, at the pixel position in the spatial arrangement in the second digital image frames corresponding to that pixel position of the second plurality of pixel positions in the second digital image frames, by interpolating the fourth data.

12. The method as in claim 1, wherein the defining step comprises, for each first pixel position in the spatial arrangement over an interval of the first digital image frames,
determining a variability in value of pixels at that pixel position of the first plurality of pixel positions over the interval,
assigning the first pixel position to the first plurality of pixel positions or the second plurality of pixel positions based upon the variability.

13. The method as in claim 12, wherein the assigning step comprises:
comparing the variability to a predetermined threshold,
if the variability is above the predetermined threshold, assigning the first pixel position to the first plurality of pixel positions, and
if the variability is below the predetermined threshold, assigning the first pixel position to the second plurality of pixel positions.

14. The method as in claim 1, wherein:
for each pixel position in the first plurality of pixel positions, the first rate is defined as a first percentage of pixels at said pixel position in the first plurality of pixel positions over a first interval of the first digital image frames,
for each pixel position in the second plurality of pixel positions, the second rate is defined as a second percentage of pixels at said pixel position in the second plurality of pixel positions over the predetermined first interval, and
the defining step comprises, for each first pixel position in the spatial arrangement over a second interval of the first digital image frames that includes the first interval,
determining a variability in value of pixels at the first pixel position over the second interval,
assigning the first pixel position to the first plurality of pixel positions or the second plurality of pixel positions based upon the variability.

15. The method as in claim 14, wherein the first interval and the second interval constitute the same first digital image frames.

16. The method as in claim 14, wherein the second interval constitutes a number of first digital image frames greater than does the first interval.

17. The method as in claim 1, wherein the plurality of first digital image frames comprise a video sequence of an instance of an additive manufacturing process.

18. A system for compressing image data, comprising:
one or more processors;
a memory coupled to the one or more processors; and
one or more computer programs stored in the memory and configured to be executed by the one or more processors, the one or more computer programs including computer executable instructions that, upon execution, perform the steps of
receiving a plurality of first digital image frames defined in a sequence to form a video sequence, each first digital image frame having a plurality of pixels within a spatial arrangement of the pixels of the plurality of pixels that is the same for all the first digital image frames in the plurality of first digital image frames,
defining a first plurality of pixel positions within the spatial arrangement and a second plurality of pixel positions within the spatial arrangement,
storing, at a computer system, first data from pixels in the first plurality of pixel positions of frames of the plurality of first digital image frames at a first rate, and
storing, at a computer system, second data from pixels in the second plurality of pixel positions of frames of the plurality of first digital image frames at a second rate,
wherein the first rate is higher than the second rate.

19. The system as in claim 18, wherein the plurality of first digital image frames comprise a video sequence of an instance of an additive manufacturing process.
